(19) United States
(12) Patent Application Publication
(10) Pub. No.: US 2012/0042248 A1
(43) Pub. Date: Feb. 16, 2012

(54) GRADUAL VISUAL FADING OF SUBSEQUENT SONGS TO REPRESENT A STREAMING PLAYLIST

(76) Inventor: David Hyman, Kensington, CA (US)

(21) Appl. No.: 13/025,958

(22) Filed: Feb. 11, 2011

Related U.S. Application Data
(60) Provisional application No. 61/303,327, filed on Feb. 11, 2010.

(51) Int. Cl. G06F 3/00; G06F 17/30

(52) U.S. Cl. 715/716; 707/770; 707/E17.014

(57) ABSTRACT

In one embodiment, a system includes a database module to store a seed data and a collection of songs. A music server is configured to generate a playlist based on a preference of a user to hear one of a plurality of songs that are known to the user and a plurality of songs that are unknown to the user. The system also includes a music device, comprising a user interface and a client module. The user device is configured to input a seed data and allow a user to control the playlist. The client module is configured to manage a dynamic change in the playlist and apply a visual effect change to the playlist. Communication between the music server and the music device is enabled through a network.

### CLAIM OF PRIORITY

This application claims priority from U.S. Provisional Application No. 61/303,327 titled “GRADUAL VISUAL FADING OF SUBSEQUENT SONGS TO REPRESENT A STREAMING PLAYLIST” filed on Feb. 11, 2010.

### FIELD OF TECHNOLOGY

This disclosure relates generally to the technical fields of communication, internet and/or music technology and, in one example embodiment, to a method, apparatus and system of gradual visual fading of subsequent songs to represent a streaming playlist.

### BACKGROUND

Music devices include radio, Compact Disk (CD) players, Digital Versatile Disk (DVD) players, iPods, etc. Music devices like radio may not provide music that a user wants to hear, therefore discouraging the user to use radio. In contrast, CD players and DVD players require CDs and DVDs that may be require space to store safely. Also, the CDs and DVDs may provide limited songs of a particular artist or a particular album. The user may lose the CDs and DVDs due to damages, improper management, etc. In addition, internet enabled devices that play music such as a computer and mobile devices may require the user to create a playlist by searching a specific song of an artist, track, etc. The user may not have the time and patience to create playlists. The disclosure described herein may present a music device that enables a user to demand music of choice, and experience the music with a degree of user participation.

### SUMMARY

Disclosed are a method, an apparatus and/or a system of gradual visual fading of subsequent songs to represent a streaming playlist.

In one aspect, a method of a music device may include presenting a list of a seed data to a user of a music device and selecting a portion of the seed data based on a preference of a user. The method may also include determining an identity of a primary song based on a match between the primary song and the preference of the user and providing the user streaming access to the primary song in a database. The method may also include retrieving a song selection history of the user from the database and determining an identity of a secondary song as one of a secondary song that is known to the user and a secondary song that is unknown to the user based on a match between the secondary song and the song selection history of the user. A playlist based on a preference of the user to hear a plurality of the secondary songs that are known to the user and a plurality of the secondary songs that are unknown to the user may then be generated. The playlist is displayed to the user to provide the user a list of songs to be played as a fading gradient of colors from a foreground color to a background color, thereby creating an illusion that the playlist is infinite.

In another aspect, a method may include the preference of the user to hear a plurality of the secondary songs that are known to the user and a plurality of the secondary songs that are unknown to the user. This preference may be indicated by sliding a slider tool to a desired point along one of a vertical, horizontal, and a diagonal axis line. The primary song may be selected based on the seed data selected by the user. The seed data may be one of a seed artist, a seed album, and a seed song, to provide the user control of the primary song. A song that has finished playing may be moved to the bottom of the playlist. The foreground color and the background color of the song may be changed accordingly. A text size on a song may be changed to a smaller text size when the song is lower on the playlist. A text font on the song may be changed to a different text font based on the position of the song on the playlist. The user may be enabled to select a song not currently playing in the playlist. The playlist may be updated if the user selects a song not currently playing in the playlist. The user may move the slider to update the playlist while the user is currently listening to the playlist.

In another aspect, a system may include a database module to store a seed data and a collection of songs and a music server to generate a playlist based on a preference of a user to hear one of a plurality of a songs that are known to the user and a plurality of a songs that are unknown to the user. The system may also include a music device, comprising a user interface and a client module, the user interface to input a seed data and allow a user to control the playlist and the client module to manage a dynamic change in the playlist and apply a visual effect change to the playlist. Communication between the music server and the music device may be enabled by a network.

In another aspect, the system may include communication between the music server and the music device as either wired communication or wireless communication. The network that enables communication may be an internet network or a cell phone communication network. The user interface may be further configured to comprise an input medium to input the seed data. The input medium may be one of a touch screen, a keyboard, a button and an external input device. The system may also include the user interface that is configured to further comprise a slider tool that allows a user to choose one of a plurality of songs that are known to the user and a plurality of songs that are unknown to the user by moving the slider tool to a desired point along one of a vertical, horizontal, and a diagonal axis line. The playlist may be configured to comprise of a list of songs to be played as a fading gradient of colors from a foreground color to a background color, thereby creating an illusion that the playlist is infinite.

In yet another aspect, a method of a music device also includes presenting a list of a seed data to a user of a music device and selecting a portion of the seed data based on a preference of a user. The method may also include determining an identity of a primary song based on a match between the primary song and the preference of the user. The music device is further configured to provide the user streaming access to the primary song in a database and retrieve a song selection history of the user from the database. The music device is configured to determine an identity of a secondary song as one of a secondary song that is known to the user and a secondary song that is unknown to the user based on a match between the secondary song and the song selection history of the user. A playlist is generated based on a preference of the user to hear one of a plurality of the secondary songs that are known to the user and a plurality of the secondary songs that are unknown to the user. The music device is further configured to display the playlist to the user to provide the user a list of songs to be played as a fading gradient of colors from a foreground color to a background color, thereby creating an illusion that the playlist is infinite. The method may also include moving a song that has finished playing to the bottom of the playlist and changing the foreground color and the background color of the song accordingly.

In yet another aspect, a method may include the preference of the user to hear one of a plurality of the secondary songs that are known to the user and a plurality of the secondary songs that are unknown to the user is indicated by sliding a slider tool to a desired point along one of a vertical, horizontal, and a diagonal axis line. The primary song may be selected based on the seed data selected by the user. The seed data may be one of a seed artist, a seed album, and a seed song, to provide the user control of the primary song. A text size on a song may be configured to be changed to a smaller text size when the song is lower on the playlist. The method may also include changing a text font on the song to a different text font based on the position of the song on the playlist. The method may further include enabling the user to select a song not currently playing in the playlist and updating the playlist if the user selects the song not currently playing in the playlist. The user may move the slider to update the playlist while the user is currently listening to the playlist. The method may also include moving a song that has finished playing to the bottom of the playlist and changing the text size and the text font of the song accordingly.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is schematic view of a music device, according to one or more embodiment.

FIG. 2 is a schematic view of an automobile having the music device, according to one or more embodiments.

FIG. 3A is a system view illustrating communication between the music device and a music server through a network, according to one or more embodiment.

FIG. 3B is an exploded view of a fading module illustrated in FIG. 3A, according to one or more embodiments.

FIG. 4 is a system view illustrating communication of electronic devices with the music server through the network, according to one or more embodiment.

FIG. 5 is a system view illustrating layers in which the system may be implemented, according to one or more embodiments.

FIG. 6 is schematic view illustrating the music device as a mobile device, according to one or more embodiments.

FIG. 7 is a schematic view illustrating a process of dynamically generating playlist for positions of slide, according to one or more embodiments.

FIG. 8 is a diagrammatic process flow illustrating a process of generation of playlist in the database layer, according to one or more embodiments.

FIG. 9 is a flow chart illustrating a process of generating an infinite playlist, according to one or more embodiments.

FIG. 10 is a diagrammatic system view of a data processing system in which any of the embodiments disclosed herein may be performed, according to one or more embodiments.

FIG. 11 is a process flow diagram detailing the operations of a method of a music device, according to one embodiment.

FIG. 12 is a process flow diagram detailing the operations of a method of a music device, according to one embodiment.

Other features of the present embodiments will be apparent from the accompanying Drawings and from the Detailed Description that follows.

### DETAILED DESCRIPTION

Gradual visual fading of subsequent songs to represent a streaming playlist method and system are disclosed. Although the embodiments have been described with reference to specific example embodiments, it will be evident that various modifications and changes may be made to these embodiments without departing from the broader spirit and scope of the various embodiments.

Music devices include radio, Compact Disk (CD) players, Digital Versatile Disk (DVD) players, iPods, etc. Music device like radio may not provide music that a user wants to hear, therefore discouraging the user to use radio. In contrast, CD players and DVD players require CDs and DVDs that may be require space to store safely. Also, the CDs and DVDs may provide limited songs of a particular artist or a particular album. The user may lose the CDs and DVDs due to damages, improper management, etc.

In addition, internet enabled devices that play music such as a computer and mobile devices may require the user to create a playlist by searching a specific song of an artist, track, etc. The user may not have the time and patience to create playlists. The disclosure described herein may present a music device that enables a user to demand music of choice, and experience the music with a degree of user participation.

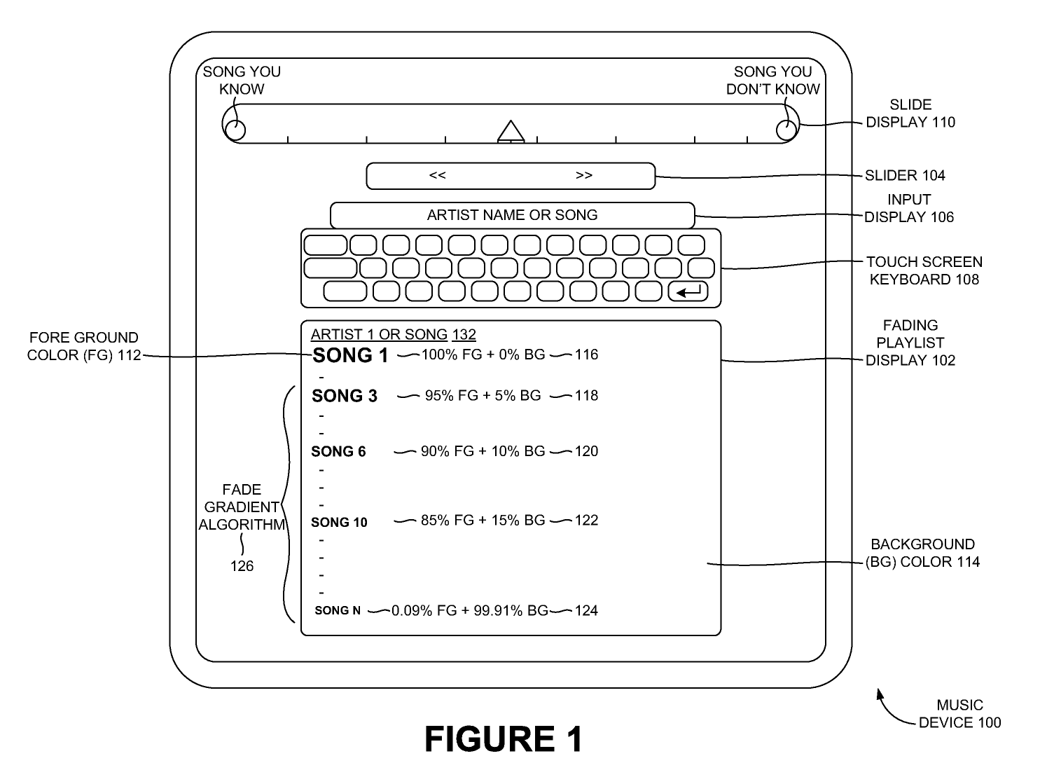

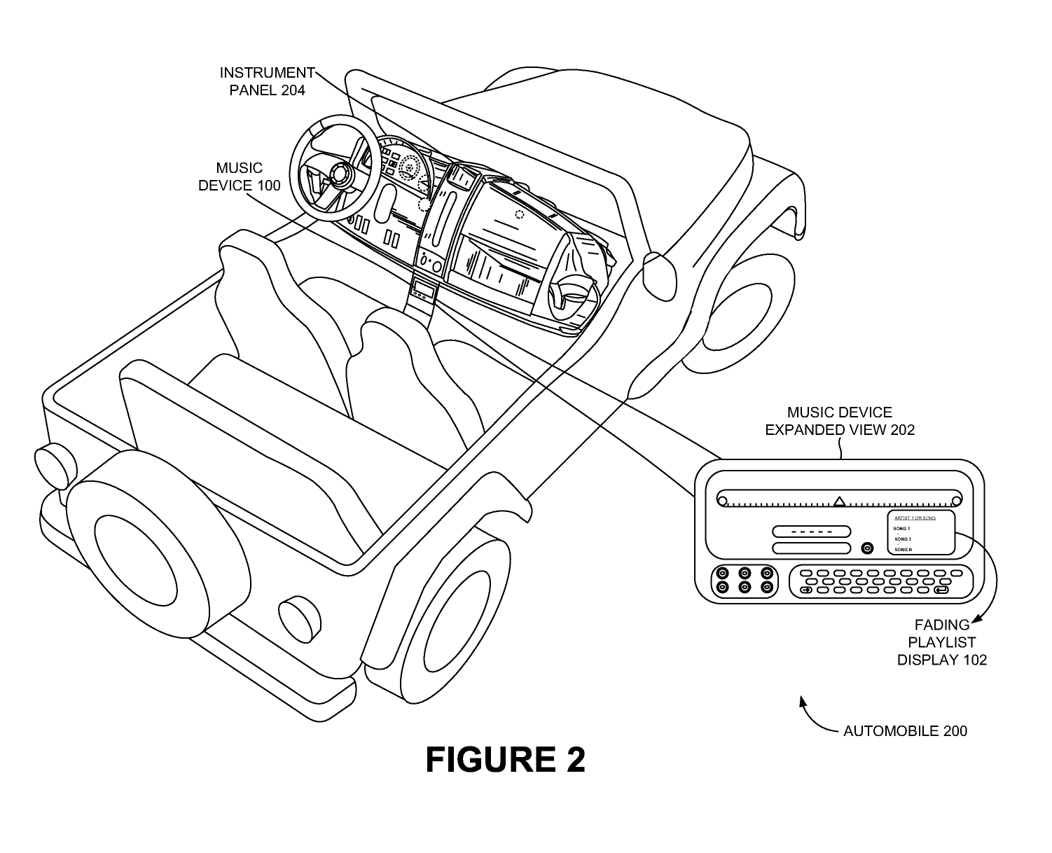

FIG. 1 is schematic view of a music device 100, according to one or more embodiment. The music device 100 may be a communication device that may communicate a request from a user to a music server. The music server may respond to the music device 100 by communicating music data (e.g., playlist) based on the request communicated by the music device 100. The music device 100 may be a hardware device or a software or combination of both. In one or more embodiments, the music device 100 may be a software program that can be installed in any compatible system (e.g., computer, mobile device, etc.). In one or more embodiments, the music device 100 may be a portable device that can be installed in an instrument panel 204 of automobile 200 as illustrated in FIG. 2. The music device 100 in the instrument panel 204 and the music device expanded view 202 may be illustrated in FIG. 2. In alternate embodiments, the music device 100 as a software may be installed in computers, mobile devices, etc.

In one or more embodiments, the music device 100 may include an input medium to input a ‘seed’. The seed may be an input by the user. For example, the seed may include an artist name, album name, and track name. The seed may be input using the input medium. Preferably, according to one embodiment, the input medium may be a touch screen 108. In alternate embodiments, the input device may include, but not be limited to, a keyboard, a button, or external input devices. The input may be displayed on an input display area 106 provided thereof. The music device 100 may also include a slider 104 that enables the user of the music device 100 to choose a spectrum for an output relative to the input. The spectrum may be defined as a range of audio files that the user may know or may not know with respect to the input seed. In one or more embodiments, adjusting the slider 104 to the left end would generate a playlist that the user may be familiar with. Similarly, adjusting the slider 104 to the right end would generate a playlist the user may not be familiar with. However, the playlist generated may be based around the seed provided by the user. The amount of slide travelled by the slider may be viewed on a slide display 110. The slide display 110 may include a slide pointer that illustrates the position of the user selection in a slide spectrum.

In addition, the music device 100 may include a fading playlist display 102. The fading playlist display 102 may be an output area that illustrates a playlist 132. Preferably, the fading playlist display 102 may be a touch screen interface. Alternatively, the fading playlist display 102 may be a Liquid Crystal Display (LCD), a Light Emitting Diode (LED), etc.

In one or more embodiments, the music device 100 may be configured to generate a playlist based on the seed provided by the user. The music device 100 may communicate the seed to the music server. The music server may generate a playlist 132 based on the seed, slider input and the user familiarity with the audio files. The playlist 132 may be displayed on the fading playlist display 102. In one or more embodiments, the playlist 132 may be displayed in descending order of contrast color enabled by a fade gradient algorithm 126. The fade gradient algorithm 126 may apply 100% of a Foreground (FG) color 112 and 0% Background (BG) color 114 to the top song or the song being played currently. Furthermore, the fade gradient algorithm 126 may gradually reduce the application of the FG color 112 and increase the application of the BG color 114 to the following playlist based on decreasing order giving an impression of fading infinite playlist.

For example, the audio file being played on the top of the playlist may have a text with color composed of low background display color, and a color that is highly contrasting the background display color. Furthermore, an audio file following the audio file being played or the audio file on the top of the playlist 132 may have text color composed of an increasing background color and decreasing contrasting background color. The audio file at the bottom of the playlist 132 may have text color that is composed of a background color and low background contrasting color. In other words, the top audio files are displayed more prominently and clearly than the audio files at the bottom of the list, i.e., the audio files at bottom are displayed as faded or small prints and as fading of font color and size. The audio files in the playlist 132 may be displayed all the time. In addition, the text size may also decrease based on the decreasing order in the playlist 132.

In an example embodiment, FIG. 1 illustrates the fading playlist display 102 with the FG color 102 and the BG color 104. In one or more embodiments, the FG color 112 may be contrasting with the BG color 114. FIG. 1 illustrates the fading order of songs enabled using the fade gradient algorithm 126. The fade gradient algorithm 126 may have applied 100% of FG 112 and 0% of BG color 114 to a song 1 116. In one or more embodiments, the song 1 may be the top song or the song being currently played. Similarly, as per the application of the fade gradient algorithm 126, a song 3 118 may have 95% of the FG color 112, and 5% of the BG color 114. Furthermore, a song 6 120 text may be composed 90% FG color 112 and 10% BG color 114, a song 10 122 text may be composed of 85% FG color 112 and 15% BG color 114. In one or more embodiments, a song N 124 that is displayed at last of playlist may have 0.09% of the FG color and 99.91% BG color 114. In one embodiment, the fading playlist display may be of different font from top to bottom with a fading effect to show a long playlist of songs. In one embodiment, the text size may be altered from top to bottom to show the fading effect of the fading playlist display 102. In one of the embodiments, the font type and size can be used to represent the fading playlist display 102. In one of the embodiments, the font type, size and fade gradient algorithm 126 can be used to show the fading playlist display 102.

In addition, when the audio file that is being played is completed, the audio file may be moved to the bottom of the playlist 132 with color being changed accordingly. The rest of the audio files may be moved up with their text color being changed accordingly. Furthermore, when the user adjusts the slider 104, a playlist as per user requested frequency may be generated and displayed on the fading playlist display 102. In other words, the playlist may be refreshed with colors being applied accordingly. Furthermore, the music device 100 is configured to change colors of the music file information dynamically whenever the background of the color is changed. In addition, the music device 100 enables the user to select any audio file in the playlist 132. In one or more embodiments, the playlist 132 may dynamically updated (e.g., change is color, position, composition of color, etc.) and reorganized, if the user selects an audio file out of order.

Furthermore, the music device 100 may enable the user to slide the slider 104 to change preferences of playlist. Accordingly, the music device 100 may communicate request to the music server for generation of new playlist. The new playlist may be generated dynamically and the fading playlist display in the music device 100 may updated with visual effects immediately.

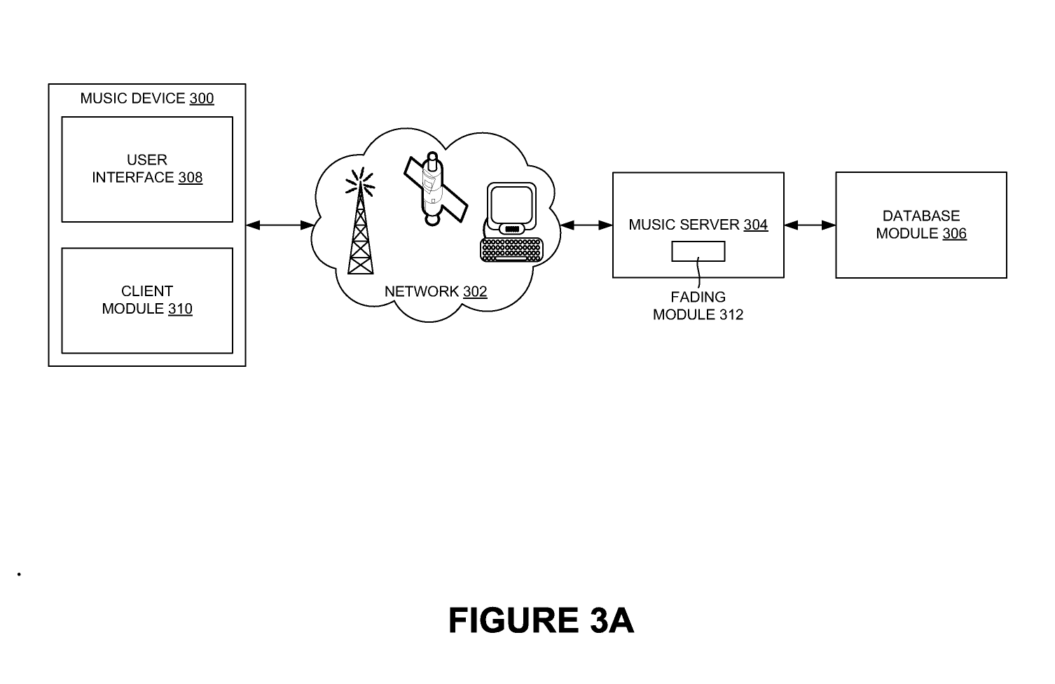

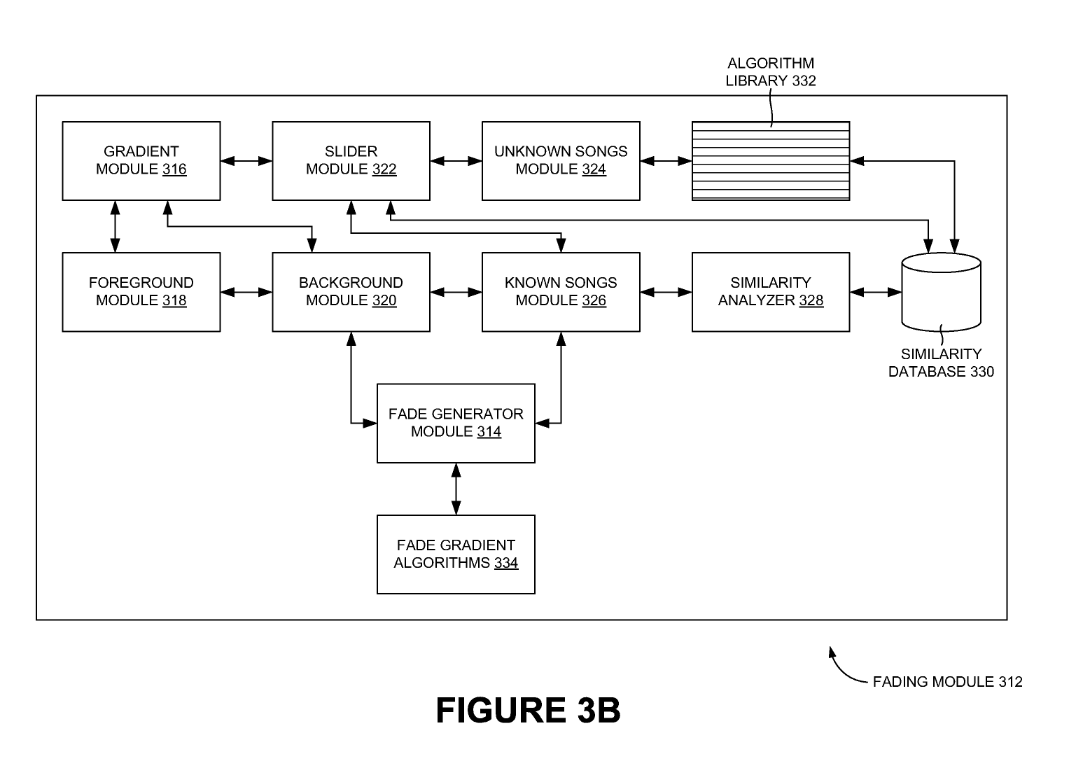

FIG. 3A is a network view illustrating communication between the music device 300 and a music server 304, according to one or more embodiment. As illustrated in FIG. 1, the music device 300 may include a user interface 308 for input and output. The seed (e.g., artist name, track name, title name, etc.) may be input to the music device through the user interface 308. In one embodiment, the music device 300 may communicate the seed to a music server 304 through a network 302. In an alternate embodiment, an electronic system that has implemented the music device 300 may communicate the seed to the music server 304 through the network 302. In one or more embodiments, the communication may be wired or wireless or both. The network 302 may enable communication between the music server 304 and the music device 300.

In one or more embodiments, the network 302 may be an internet, cell phone communication network, etc. The music server 304 may receive a request from the music device 300 and respond based on the input seed. The music server 304 may use the seed and other information from the music device 300 to query a database module 306. In one or more embodiments, the database module 306 may process the query to generate a playlist. The playlist may be based on the seed, the user familiarity with the audio file, etc. In one or more embodiments, the music server 304 may include a familiarity module (not shown in figure). The familiarity module may collect information associated with user and user's familiarity with songs. In one or more embodiments, the familiarity module may track user requests and number of times a particular song being played to gauge the user familiarity with the song. The generated playlist may be then communicated to the music device 300 through the network 302. The fading module 312 may communicate with a client module 310 in the music device 300 to apply visual effects (e.g., colors, designs, fonts, text, etc.) to the playlist in the music device 300. In one or more embodiments, the fading module 312 may provide skin color, themes and other visual effects to the client module 310. In addition, the client module 310 may also manage the dynamic changes in the playlist and applies the visual effects to the changed playlist content. Furthermore, all the visual effects, changes and dynamic updating, etc, may be performed by the client module 310 controlled by the fading module 312 of the music server 304.

FIG. 3B is an exploded view of the fading module 312 illustrated in FIG. 3A, according to one or more embodiments. In particular, FIG. 3B illustrates a fade generator module 314, a gradient module 316, a foreground module 318, a background module 320, a slider module 322, unknown songs module 324, known songs module 326, a similarity analyzer 328, a similarity database 330, an algorithm library 332, and fade gradient algorithms 334, according to one embodiment.

The foreground module 318 and the background module 320 may provide colors, font, screen and other attributes to the fading playlist display 102. The gradient module 316 may provide visual effect based on fade gradient algorithms 334. In one or more embodiments, the gradient module 316 may control the foreground module 318 and the background module 320 for providing fading effect in the fading playlist display 102. In one or more embodiments, the fade generator module 314 communicatively coupled with the fade gradient algorithms 334 may control the fading effect in the fading playlist display 102.

The slider module 322 may be coupled with the gradient module 316, the unknown songs module 324 and the known songs module 326. In one or more embodiments, the slider module 322 may generate a playlist composed of known songs and unknown songs based on the position of the slider 104. In one or more embodiments, the slider module 322 may communicate with the known songs module 326 and the unknown songs module 324 to generate the playlist. The known songs module 326 may generate a list of known songs based on the user profile. In one embodiment, the known songs may be determined by number of times the user has played a particular song. In one or more embodiments, the unknown songs module 324 may track the user and number of times a song played to determine the familiarity with a particular song. In one or more embodiments, the slider module 322 may be communicatively coupled to a similarity analyzer 328. The similarity analyzer 328 may analyze the seed input by the user to generate a playlist based on the similar items associated with the seed. In one or more embodiments, the similarity analyzer 328 may communicate generate the playlist based on seed and similar items (e.g., unknown songs but similar to known songs) from the similarity database 330. In one or more embodiments, the similar songs or similar items may refer to unknown songs associated with same artist, album, etc. However, the similar items may be associated with the input seed. The similarity database 330 may include a collection of songs that may be linked to each other. The algorithm library 332 may include several algorithms required for functioning fading module 312.

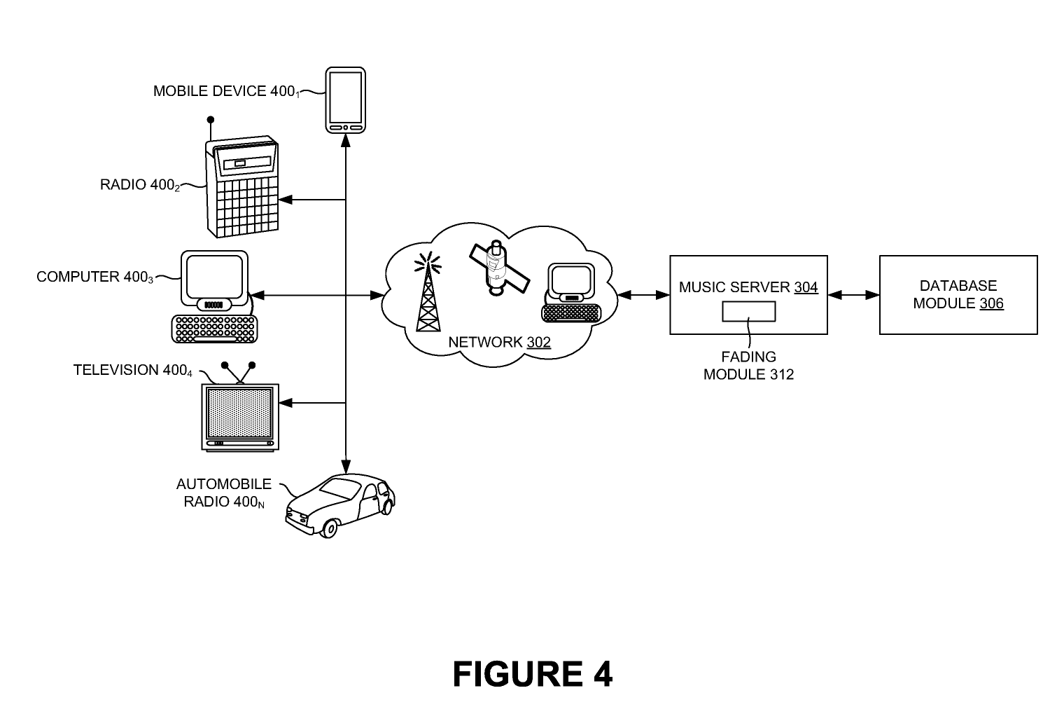

FIG. 4 is a network view illustrating communication of electronic devices with the music server 304 through the network 302, according to one or more embodiment. As described in previous figures, the music device may 300 be a software enabled hardware device. In one or more embodiments, a software version of the music device 100 may be installed in a compatible device (e.g., computer, mobile device). FIG. 4 illustrates several electronic devices communicating that may include music device 300 in each of the electronic devices communicating with the music server 304. In one or more embodiments, the electronic devices may include, but not limited to a mobile device 400₁, a digital radio 400₂, a computer 400₃, a television 400₄, and an automobile radio 400_{N}.

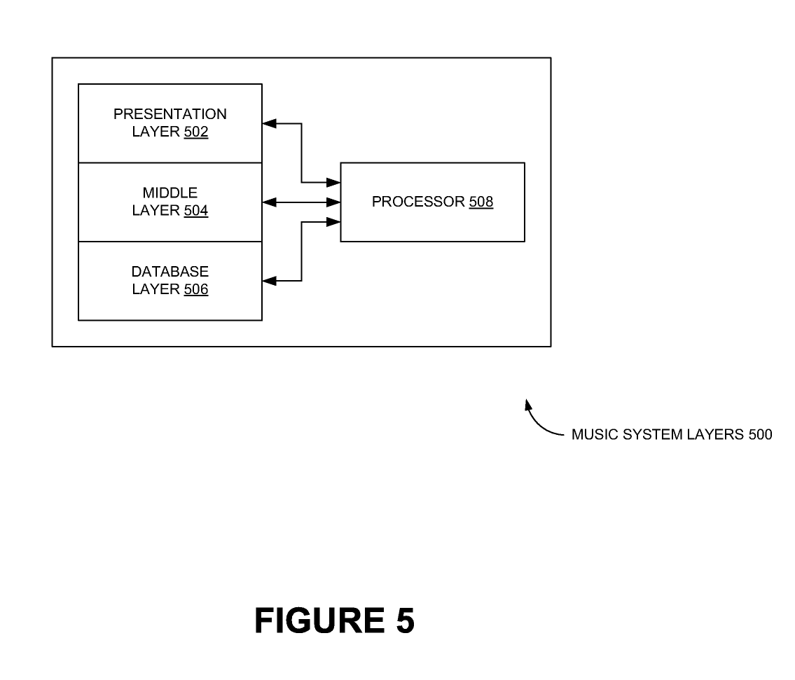

FIG. 5 is a schematic view illustrating music system layers 500 in which a music system may be implemented, according to one or more embodiments. According to one embodiment, FIG. 5 illustrates a presentation layer 502, a middle layer 504, a database layer 506 and a processor operating in the middle layer 504 an the database layer 506. The presentation layer 502 may be associated with display and presentation of data. In one or more embodiments, the data being presented in the presentation layer 502 may be controlled by the client module 310. The presentation of data may include, but not be limited to, fading presentation of a playlist, dynamic display of playlist, auto-refresh of a music playlist, placement of text, skin color manipulation, slide controls, and slide display. The middle layer 504 may be associated with communication of data between the music device 100 and the music server 304. The middle layer 504 may connect the database layer 506 to the presentation layer 502. For example, when a user requests an audio of a particular artist, the requested audio and the other audios related to the artist may be searched in a database present in the database layer 506 and a list of audios may be displayed in the presentation layer 502 (e.g., the fading playlist display 102 of FIG. 1).The database layer 506 may include database of artists, database of tracks, etc. The database layer 506 may process the query provided by the middle layer 504 to generate a result to be presented in the presentation layer 502. The generation of a query, processing of the query, generating a playlist as a result and presenting the playlist in the presentation layer may be coordinated and managed by the processor 508.

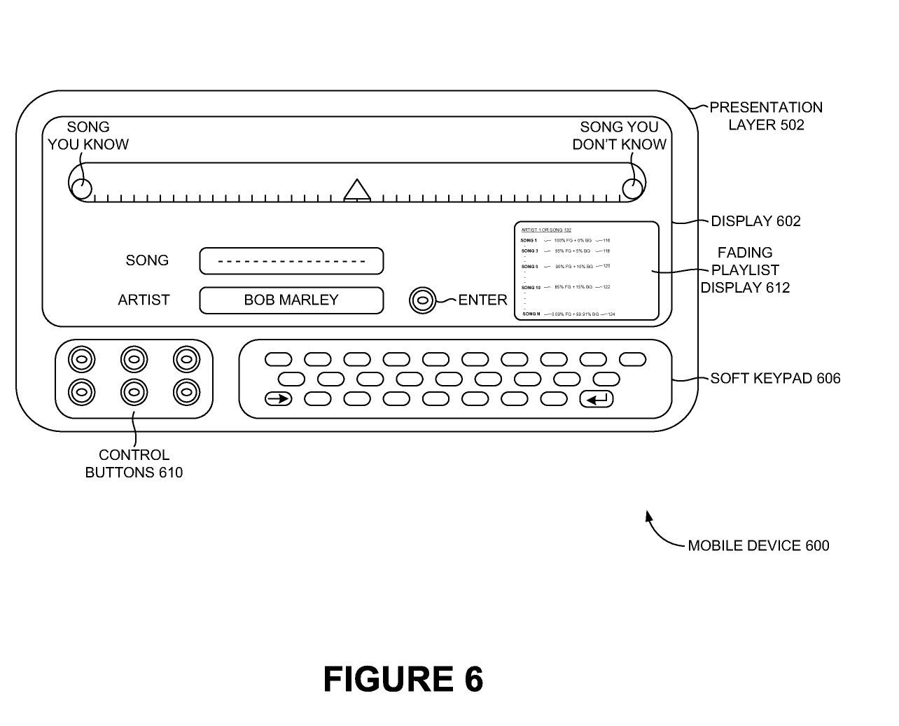

FIG. 6 is a schematic view illustrating the music device 100 as a mobile device 600, according to one or more embodiments. As mentioned in the above figures, the music device 100 may be a portable or mobile device 600. In one or more embodiments, the music device 100 may be designed as the mobile device 600. The mobile device 600 may include a presentation layer 502 that outputs the visuals of the song information along with slide information in the display 602. The display 602 may be a LCD or a LED screen to provide visuals of the audio information. In addition, the mobile device 600 may also include an input device such as a soft keypad 606 for input of seeds into the mobile device 600. Furthermore, the mobile device 600 may include control buttons 610 for controlling the mobile device 600. The control buttons 610 may include, but not limited to on/off, pause, play, fast forward, and rewind.

In one or more embodiments, the mobile device 600 may be battery operated. In alternate embodiments, the mobile device 600 may be operated using direct power supply as well. Furthermore, the mobile device 600 may include a power port for connecting with a power line for recharging battery. In addition, the mobile device 600 may include a communication module (not shown in figure) that may communicate the seed information to the music server 304 and obtains the audio information from the music server 304 through the network 302. The communication module in the mobile device 600 may operate through wired communication or wireless communication. Preferably, the communication module may use Universal Serial Bus (USB) for communicating through wires. However, it has to be noted that the communication through wires may not be restricted to USB only, but to any other feasible mode of wired communication.

In one or more embodiments, the mobile device 600 (e.g., the portable music device 100) may include a fading playlist display area 102 that displays a playlist (e.g., fading playlist) with the decreasing order songs text composed of fading foreground color and increasing background color (e.g., as illustrated in FIG. 1).

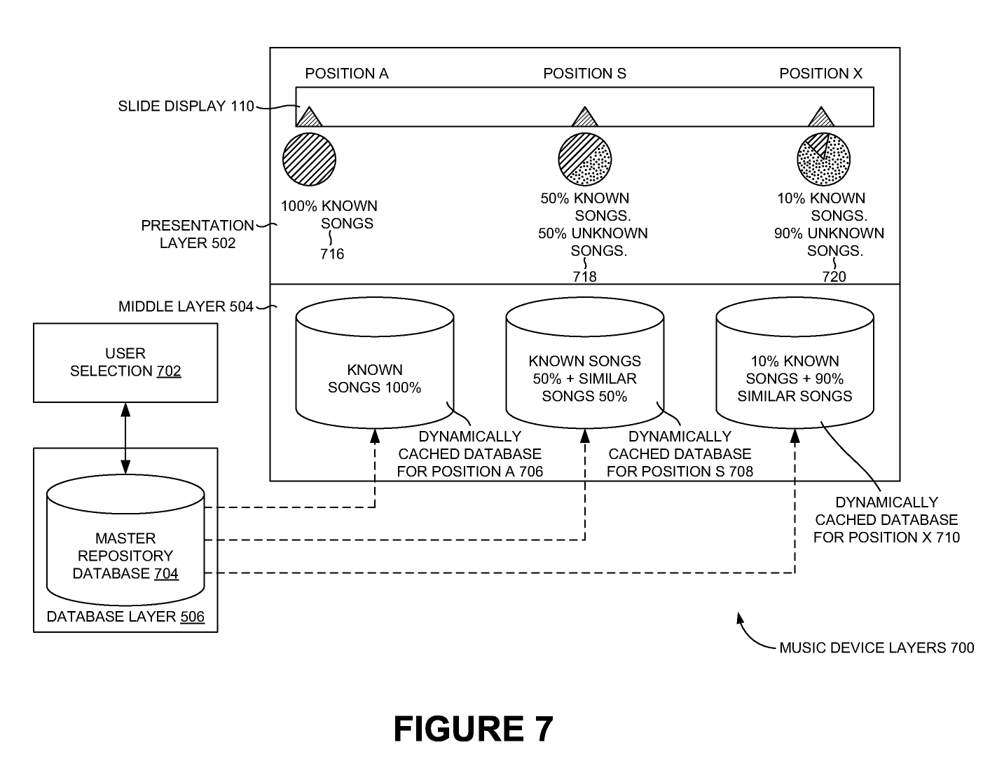

FIG. 7 is a schematic view illustrating a process of dynamically generating playlist for positions of slide, according to one or more embodiments. FIG. 7 illustrates music device layers 700. As described in FIG. 1, the music device 100 may enable the user to use a slider 104 to slide to choose a spectrum for an output (e.g., playlist) relative to the input. The spectrum may define a range of audio files that the user may know or may not know with respect to the input seed. In one or more embodiments, the user may use the slider 104 to choose a playlist (based on a seed) from a spectrum that is composed of a percentage that the user may know and rest composed of an audio that the user may not know. In one or more embodiments, the music device 100 may communicate the seed to the music server 304. The music server 304 may communicate a playlist based on the seed. In one or more embodiments, the client module 310 may generate a dynamic playlist and may communicate the playlists for each of the position of the slider 104. The playlists in the music devices 100 may be stored in dynamically cached database for each of positions of the slider 104. FIG. 7 illustrates the process of storing the playlist in dynamically cached database for different slide positions in the middle layer 504.

In the example embodiment, FIG. 7 illustrates a user selection 702 (e.g., the seed) being communicated to a master repository database 704 in the database layer 506. The master repository database 704 may include artist information, audio information, user information, etc. The database layer 506 may generate the playlist based on the user selection (e.g., seed). In one or more embodiments, the database layer 506 may generate playlist for all possible positions in the slider 104 in the slide display 110. The playlist generated for each of the position of the slider may be stored in a cache memory of the music device 100.

In example embodiment, FIG. 7 illustrates a playlist generated and stored in dynamically cached database for position A 706, the position A representing request for songs that are completely known by user or 100% known songs 716. Similarly, position S of slider 104 that requests generation of 50% known songs and 50% unknown songs 718 (or similar songs) in a playlist. The playlist generated may be stored in a dynamically cached database for the position S 708. Another example illustrates a position X of slider that may communicate a request for generation of playlist that is composed of 10% known songs and 90% unknown songs 720 (e.g., similar songs) known by a user and a corresponding playlist generated and stored in a dynamically cached database for position X 710. All the slide positions and requests are performed in the presentation layer 502, storage and caching may be performed at the middle layer 504 and generation of playlist may be performed at the database layer 506.

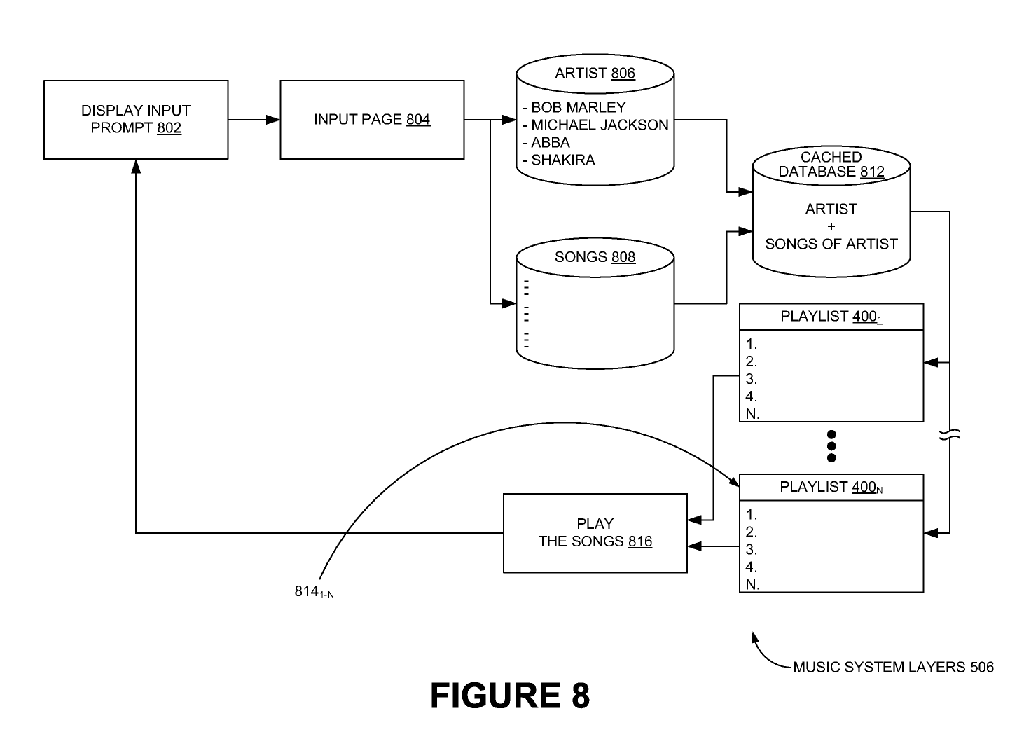

FIG. 8 is a diagrammatic process flow illustrating a process of generation of playlist in the database layer 506, according to one or more embodiments. In operation 802, audio associated with previous request may be continuously played along with an option for input request in display. In operation 804, a seed may be input in an input page and communicated to the database layer 506. In operation 806 and 808, artist data and song data based on the seed may be searched in an artist database and in a song database. In operation 812, the artist and the song information may be collected in the cached database. In operation 814_{1-N}, a number of playlists based on seed and positions of slide may be generated. In operation 816, the songs may be played with information on display unit.

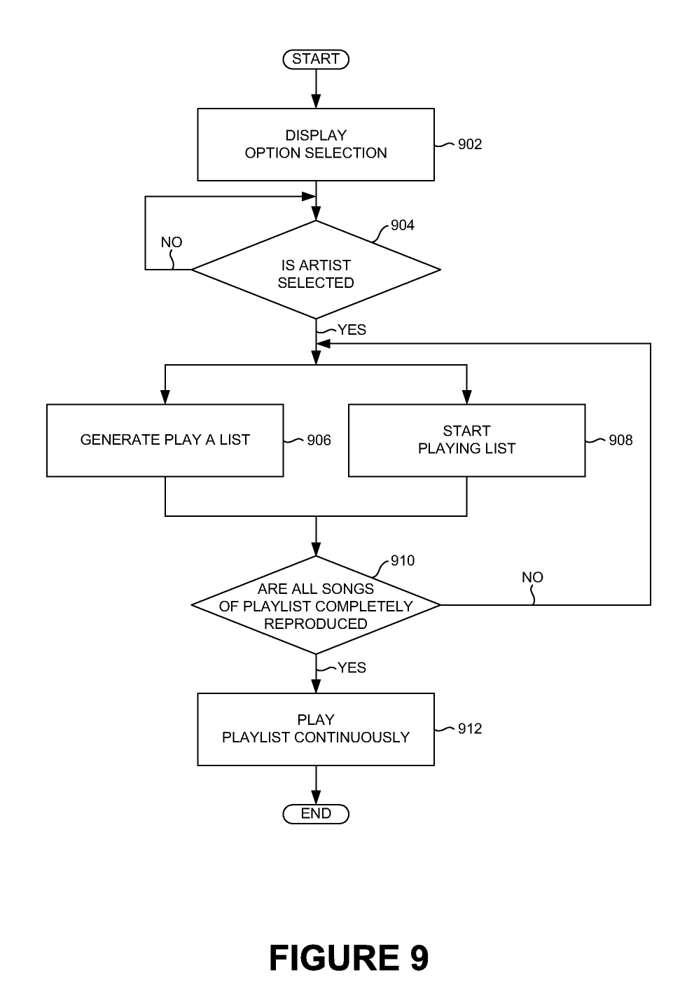

FIG. 9 is a flow chart illustrating a process of generating an infinite playlist, according to one or more embodiments. In operation 902, a display option may be selected. In operation 904, selection of artist may be determined. If the artist is selected, then operations 906 and 908 are performed. If the artist is not selected, then operation 904 is performed. In operation 906, a playlist may be generated. In operation 908, playlist may be played. In operation 910, it may be determined that all songs of the playlist are completely reproduced. If all the songs are reproduced, then the playlist may be played continuously in operation 912. If all the songs are not reproduced then the operations 906 and 908 are performed.

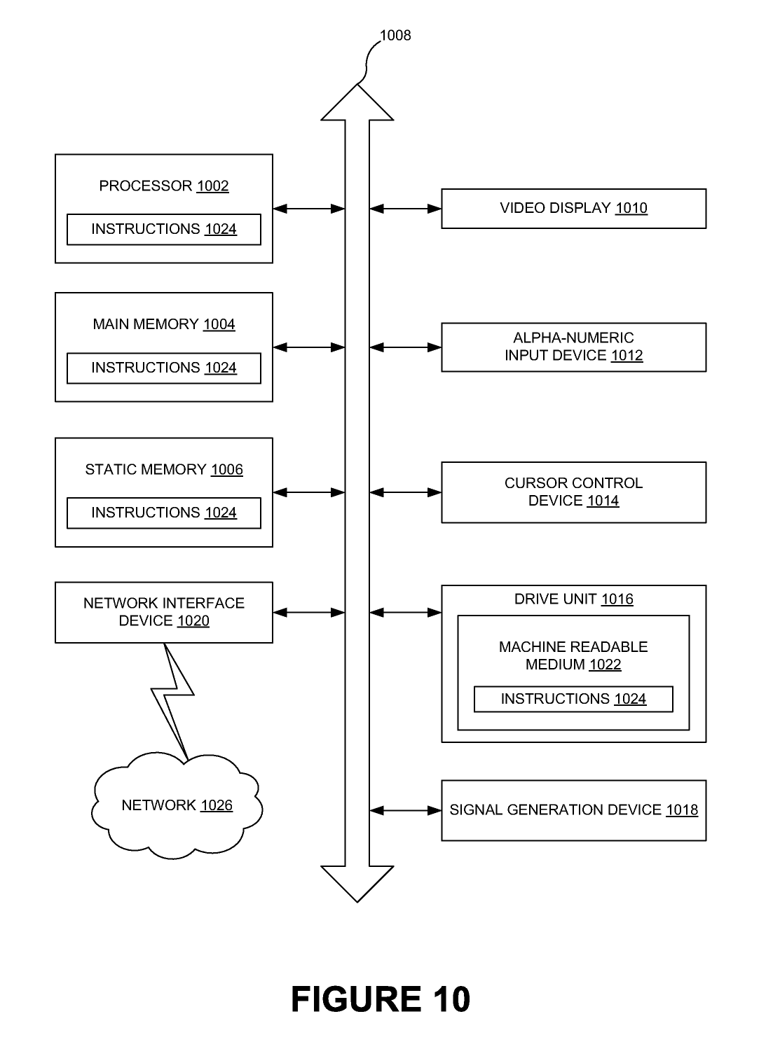

FIG. 10 is a diagrammatic system view of a data processing system in which any of the embodiments disclosed herein may be performed, according to one embodiment. Particularly, the diagrammatic system view 1000 of FIG. 10 illustrates a processor 1002, a main memory 1004, a static memory 1006, a bus 1008, a video display 1010, an alpha-numeric input device 1012, a cursor control device 1014, a drive unit 1016, a signal generation device 1018, a network interface device 1020, a machine readable medium 1022, instructions 1024, and a network 1026, according to one embodiment.

The diagrammatic system view 1000 may indicate a personal computer and/or the data processing system in which one or more operations disclosed herein are performed. The processor 1002 may be a microprocessor, a state machine, an application specific integrated circuit, a field programmable gate array, etc. The main memory 1004 may be a dynamic random access memory and/or a primary memory of a computer system.

The static memory 1006 may be a hard drive, a flash drive, and/or other memory information associated with the data processing system. The bus 1008 may be an interconnection between various circuits and/or structures of the data processing system. The video display 1010 may provide graphical representation of information on the data processing system. The alpha-numeric input device 1012 may be a keypad, a keyboard and/or any other input device of text (e.g., a special device to aid the physically handicapped).

The cursor control device 1014 may be a pointing device such as a mouse. The drive unit 1016 may be the hard drive, a storage system, and/or other longer term storage subsystem. The signal generation device 1018 may be a bios and/or a functional operating system of the data processing system. The network interface device 1020 may be a device that performs interface functions such as code conversion, protocol conversion and/or buffering required for communication to and from the network 1026. The machine readable medium 1022 may provide instructions on which any of the methods disclosed herein may be performed. The instructions 1024 may provide source code and/or data code to the processor 1002 to enable any one or more operations disclosed herein.

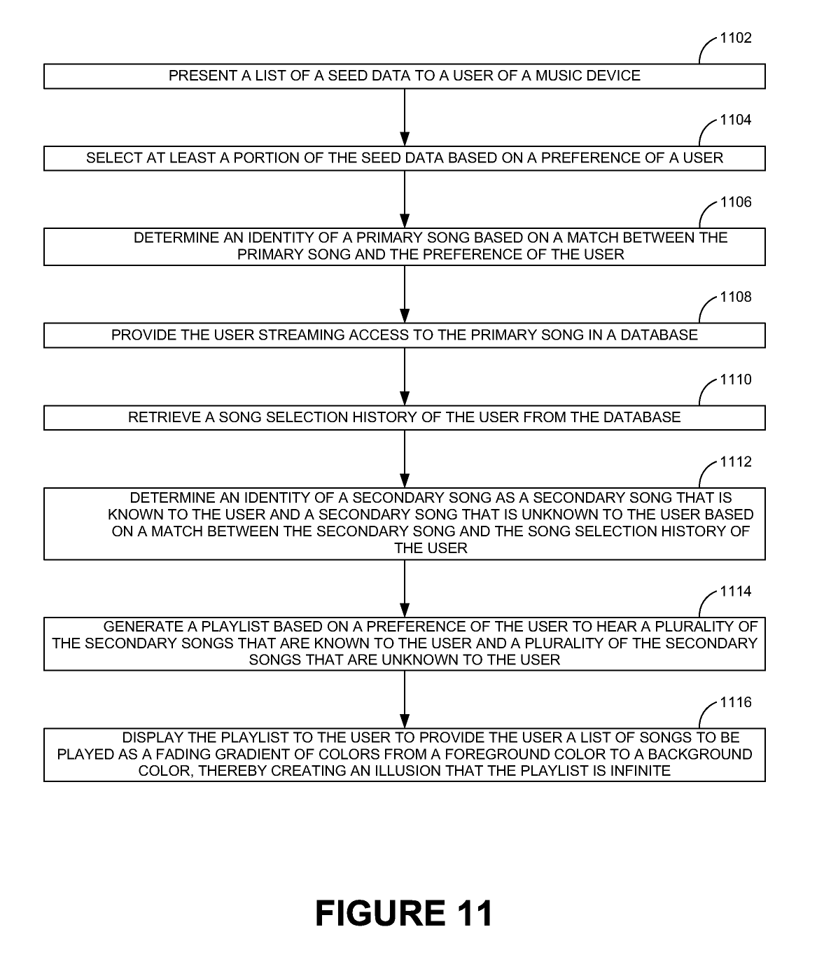

FIG. 11 is a process flow diagram detailing the operations involved in a method of a music device, according to one embodiment. In one embodiment, operation 1102 may involve presenting a list of a seed data to a user of a music device. In one embodiment, operation 1104 may involve selecting a portion of the seed data based on a preference of a user. In one embodiment, operation 1106 may involve determining an identity of a primary song based on a match between the primary song and the preference of the user. In one embodiment, operation 1108 may involve providing the user streaming access to the primary song in a database. In one embodiment, operation 1110 may involve retrieving a song selection history of the user from the database. In one embodiment, operation 1112 may involve determining an identity of a secondary song as one of a secondary song that is known to the user and a secondary song that is unknown to the user based on a match between the secondary song and the song selection history of the user. In one embodiment, operation 1114 may involve generating a playlist based on a preference of the user to hear one of a plurality of the secondary songs that are known to the user and a plurality of the secondary songs that are unknown to the user. In one embodiment, operation 1116 may involve displaying the playlist to the user to provide the user a list of songs to be played as a fading gradient of colors from a foreground color to a background color, thereby creating an illusion that the playlist is infinite.

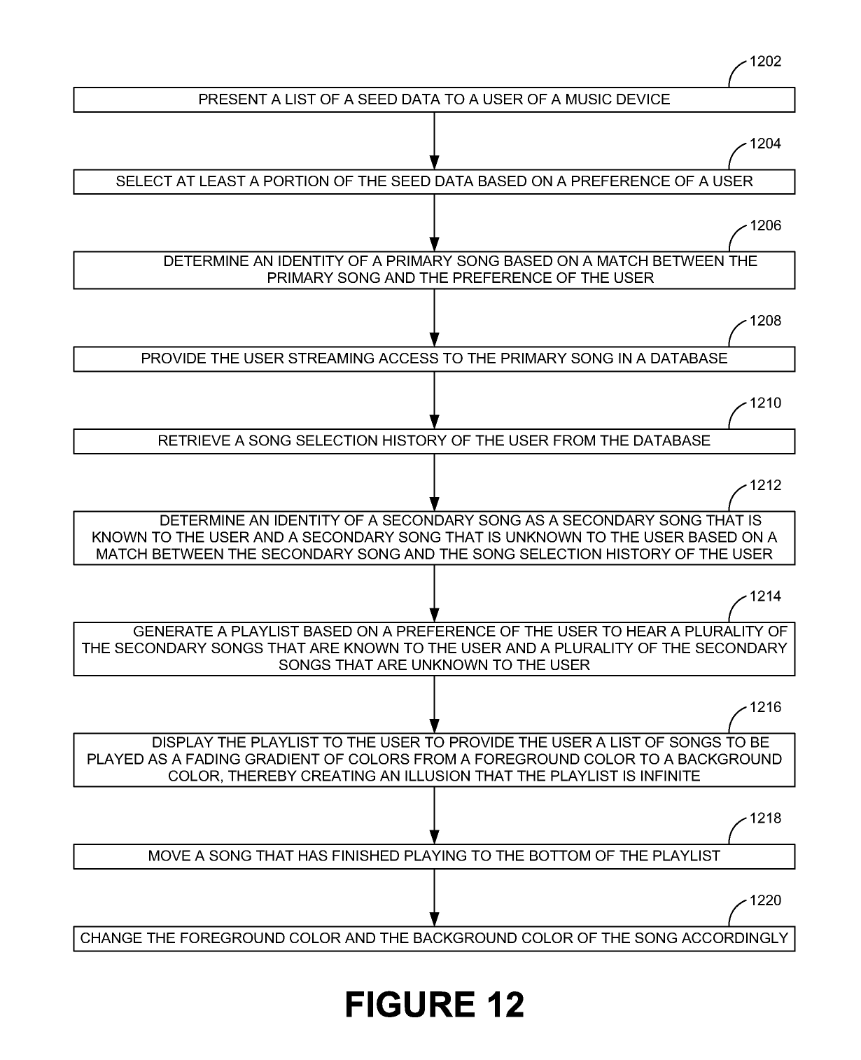

FIG. 12 is a process flow diagram detailing the operations involved in a method of a music device, according to one embodiment. In one embodiment, operation 1202 may involve presenting a list of a seed data to a user of a music device. In one embodiment, operation 1204 may involve selecting a portion of the seed data based on a preference of a user. In one embodiment, operation 1206 may involve determining an identity of a primary song based on a match between the primary song and the preference of the user. In one embodiment, operation 1208 may involve providing the user streaming access to the primary song in a database. In one embodiment, operation 1210 may involve retrieving a song selection history of the user from the database. In one embodiment, operation 1212 may involve determining an identity of a secondary song as one of a secondary song that is known to the user and a secondary song that is unknown to the user based on a match between the secondary song and the song selection history of the user. In one embodiment, operation 1214 may involve generating a playlist based on a preference of the user to hear one of a plurality of the secondary songs that are known to the user and a plurality of the secondary songs that are unknown to the user. In one embodiment, operation 1216 may involve displaying the playlist to the user to provide the user a list of songs to be played as a fading gradient of colors from a foreground color to a background color, thereby creating an illusion that the playlist is infinite. In one embodiment, operation 1218 may involve moving a song that has finished playing to the bottom of the playlist. In one embodiment, operation 1220 may involve changing the foreground color and the background color of the song accordingly.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software or any combination of hardware, firmware, or software (e.g., embodied in a machine readable medium). For example, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system (e.g., a computer system), and may be performed in any order (e.g., including using means for achieving the various operations). Accordingly, the Specification and Drawings are to be regarded in an illustrative rather than a restrictive sense.

What is claimed is:

1. A method of a music device, comprising:
presenting a list of a seed data to a user of a music device;
selecting at least a portion of the seed data based on a preference of a user;
determining an identity of a primary song based on a match between the primary song and the preference of the user;
providing the user streaming access to the primary song in a database;
retrieving a song selection history of the user from the database;
determining an identity of a secondary song as at least one of a secondary song that is known to the user and a secondary song that is unknown to the user based on a match between the secondary song and the song selection history of the user;
generating a playlist based on a preference of the user to hear at least one of a plurality of the secondary songs that are known to the user and a plurality of the secondary songs that are unknown to the user; and
displaying the playlist to the user to provide the user a list of songs to be played as a fading gradient of colors from a foreground color to a background color, thereby creating an illusion that the playlist is infinite.

2. The method of claim 1, wherein the preference of the user to hear at least one of a plurality of the secondary songs that are known to the user and a plurality of the secondary songs that are unknown to the user is indicated by sliding a slider tool to a desired point along at least one of a vertical, horizontal, and a diagonal axis line.

3. The method of claim 1, further comprising:
selecting the primary song based on the seed data selected by the user, wherein the seed data is at least one of a seed artist, a seed album, and a seed song, to provide the user control of the primary song.

4. The method of claim 1, further comprising:
moving a song that has finished playing to the bottom of the playlist; and
changing the foreground color and the background color of the song accordingly.

5. The method of claim 1, further comprising changing a text size on a song to a smaller text size when the song is lower on the playlist; and
changing a text font on the song to a different text font based on the position of the song on the playlist.

6. The method of claim 1, further comprising:
enabling the user to select a song not currently playing in the playlist;
updating the playlist if the user selects the song not currently playing in the playlist.

7. The method of claim 3, wherein the user moves the slider to update the playlist while the user is currently listening to the playlist.

8. A system comprising:
a database module to store a seed data and a collection of songs;
a music server to generate a playlist based on a preference of a user to hear at least one of a plurality of songs that are known to the user and a plurality of songs that are unknown to the user;
a music device, comprising a user interface and a client module;
the user interface to input a seed data and allow a user to control the playlist;
the client module to manage a dynamic change in the playlist and apply a visual effect change to the playlist; and
a network to enable communication between the music server and the music device.

9. The system of claim 8, wherein the communication between the music server and the music device is at least one of wired communication and wireless communication.

10. The system of claim 8, wherein the network is at least one of an internet network and a cell phone communication network.

11. The system of claim 8, wherein the user interface further comprises an input medium to input the seed data, wherein the input medium is at least one of a touch screen, a keyboard, a button and an external input device.

12. The system of claim 8, wherein the user interface further comprises a slider tool that allows a user to choose at least one of a plurality of songs that are known to the user and a plurality of songs that are unknown to the user by moving the slider tool to a desired point along at least one of a vertical, horizontal, and a diagonal axis line.

13. The system of claim 8, wherein the playlist comprises a list of songs to be played as a fading gradient of colors from a foreground color to a background color, thereby creating an illusion that the playlist is infinite.

14. A method of a music device, comprising:
presenting a list of a seed data to a user of a music device;
selecting at least a portion of the seed data based on a preference of a user;
determining an identity of a primary song based on a match between the primary song and the preference of the user;
providing the user streaming access to the primary song in a database;
retrieving a song selection history of the user from the database;
determining an identity of a secondary song as at least one of a secondary song that is known to the user and a secondary song that is unknown to the user based on a match between the secondary song and the song selection history of the user;
generating a playlist based on a preference of the user to hear at least one of a plurality of the secondary songs that are known to the user and a plurality of the secondary songs that are unknown to the user;
displaying the playlist to the user to provide the user a list of songs to be played as a fading gradient of colors from a foreground color to a background color, thereby creating an illusion that the playlist is infinite;
moving a song that has finished playing to the bottom of the playlist; and
changing the foreground color and the background color of the song accordingly.

15. The method of claim 14, wherein the preference of the user to hear at least one of a plurality of the secondary songs that are known to the user and a plurality of the secondary songs that are unknown to the user is indicated by sliding a slider tool to a desired point along at least one of a vertical, horizontal, and a diagonal axis line.

16. The method of claim 14, further comprising:
selecting the primary song based on the seed data selected by the user, wherein the seed data is at least one of a seed artist, a seed album, and a seed song, to provide the user control of the primary song.

17. The method of claim 14, further comprising
changing a text size on a song to a smaller text size when the song is lower on the playlist; and
changing a text font on the song to a different text font based on the position of the song on the playlist.

18. The method of claim 14, further comprising:
enabling the user to select a song not currently playing in the playlist;
updating the playlist if the user selects the song not currently playing in the playlist.

19. The method of claim 14, wherein the user moves the slider to update the playlist while the user is currently listening to the playlist.

20. The method of claim 17, further comprising:
moving a song that has finished playing to the bottom of the playlist; and
changing the text size and the text font of the song accordingly.
